(19) United States
(12) Patent Application Publication
(10) Pub. No.: US 2014/0173927 A1
(43) Pub. Date: Jun. 26, 2014

(54) FOLDER TYPE UV CURING MACHINE FOR NAILS

(71) Applicant: JC KOREA CORP., Gyeonggi-do (KR)

(72) Inventors: Dong Sung Kim, Gyeonggi-do (KR); Hyun Surk Kim, Gyeonggi-do (KR); Kyung Sik Choi, Gyeonggi-do (KR); Ju Young Park, Gyeonggi-do (KR); Jeong Rim Choi, Gyeonggi-do (KR); Bo Mi Kim, Seoul (KR)

(73) Assignee: JC KOREA CORP., Gyeonggi-do (KR)

(21) Appl. No.: 13/971,233

(22) Filed: Aug. 20, 2013

(30) Foreign Application Priority Data
Dec. 24, 2012 (KR) 10-2012-0152280
May 31, 2013 (KR) 10-2013-0062365

(51) Int. Cl. A45D 29/20; F26B 3/28

(52) U.S. Cl. CPC A45D 29/20; F26B 3/28
USPC 34/275

(57) ABSTRACT

Provided is a folder type UV curing machine for nails, which includes a lower member on which a curing target is placed, and an upper member coupled to the lower member by means of a hinge based on a shaft to be rotatable within a predetermined angle based on the shaft, the upper member having a lighting unit for emitting ultraviolet rays toward the lower member.

### CROSS-REFERENCE TO RELATED APPLICATIONS

This application claims priority under 35 U.S.C. §119 to Korean Patent Application Nos. 10-2012-0152280 filed on Dec. 24, 2012 and 10-2013-0062365 filed on May 31, 2013, in the Korean Intellectual Property Office, the disclosures of which are incorporated herein by reference in their entirety.

### TECHNICAL FIELD

The following disclosure relates to a folder type UV curing machine for nails.

### BACKGROUND

As one of modes for expressing physical beauty pursued by the human being, the cosmetic business is developing faster and subdivided into various industries. In particular, from the 20^{th} century, the cosmetic market is rapidly increasing, and the cosmetic business becomes more popular to the public. Among the cosmetic industries, the nail art is developing fast in these days as an essential element of expressional arts regardless of age and sex.

In principle, the nail art is one of methods for decorating a human body as one of beauty arts, and the length, shape and color of nails represent the change and value of the culture.

The nail art is performed using various materials, and ultra violet gel (UV gel) is recently spotlighted. The UV gel is cured with ultraviolet rays and has various advantages. First, the UV gel has no provocative smell and is not easily broken due to flexible and soft natures. In addition, the UV gel is not discolored even though it is exposed to the sun light, and it has excellent gloss and no harm to the human body. Further, the UV gel may be designed in various ways and also allows a cubic 3D art.

However, in order to cure the UV gel, a UV curing machine should be separately used. As disclosed in the patent documents of the related art, a general UV curing machine has so large size not to be easily carried. In addition, since an accurate position for effective curing is not known, the curing efficiency is bad. Further, the ultraviolet rays reflected by the bottom of a drying room may give a bad influence on the eyes of a user. In addition, since the bottom of the drying room is flat, the fingers may not be naturally moved during the curing process.

### SUMMARY

An embodiment of the present disclosure is directed to providing a folder type UV curing machine for nails, which has a small size to be easily carried since a lower member and an upper member are coupled by a hinge.

The present disclosure is also directed to providing a folder type UV curing machine for nails, which may allow a user to check an accurate position for effective curing since a dent portion is formed to display a position of a curing target.

The present disclosure is also directed to providing a folder type UV curing machine for nails, which may allow a user to conveniently place the fingers during a curing process and also ensure a suitable distance from the nail serving as a curing target to a lighting unit since the dent portion is formed with a slant.

In one general aspect, there is provided a folder type UV curing machine for nails, which includes: a lower member on which a curing target is placed; and an upper member coupled to the lower member by means of a hinge based on a shaft to be rotatable within a predetermined angle based on the shaft, the upper member having a lighting unit for emitting ultraviolet rays toward the lower member.

In addition, in the folder type UV curing machine for nails according to the embodiment of the present disclosure, the lighting unit may be a light emitting diode ultraviolet lamp (LED UV lamp).

In addition, in the folder type UV curing machine for nails according to the embodiment of the present disclosure, the lower member may have a dent portion formed to display a position of the curing target.

In addition, the folder type UV curing machine for nails according to the embodiment of the present disclosure may further include a reflection unit formed at the lower member to reflect the ultraviolet rays.

In addition, the folder type UV curing machine for nails according to the embodiment of the present disclosure may further include an uneven portion formed at the reflection unit.

In addition, the folder type UV curing machine for nails according to the embodiment of the present disclosure may further include a prism sheet formed at the reflection unit.

In addition, the folder type UV curing machine for nails according to the embodiment of the present disclosure may further include a display unit provided at the upper member and emitting light toward the lower member to display a position of the curing target.

In addition, in the folder type UV curing machine for nails according to the embodiment of the present disclosure, the light may be a visible ray.

In addition, the folder type UV curing machine for nails according to the embodiment of the present disclosure may further include a matt layer formed at an upper surface of the lower member.

In addition, in the folder type UV curing machine for nails according to the embodiment of the present disclosure, the upper surface of the lower member may have a surface roughness of Ra=0.5a to 15a, Rz=2.0z to 100z.

In another aspect of the present disclosure, there is provided a folder type UV curing machine for nails, which includes: a lower member on which a curing target is placed; an upper member coupled to the lower member by means of a hinge based on a shaft to be rotatable within a predetermined angle based on the shaft; and a lighting unit provided at the upper member to emit ultraviolet rays toward the lower member, wherein a dent portion is formed at one surface of the lower member, which faces the upper member, to display a position of the curing target, and wherein the dent portion is inclined to have a greater depth as closer to the shaft.

In the folder type UV curing machine for nails according to another embodiment of the present disclosure, the dent portion may include: a first dent portion having a first inclined angle; and a second dent portion extending from the first dent portion toward the shaft and having a second inclined angle different from the first inclined angle.

In the folder type UV curing machine for nails according to another embodiment of the present disclosure, the second inclined angle may be greater than the first inclined angle.

In the folder type UV curing machine for nails according to another embodiment of the present disclosure, a step portion protruding upwards may be formed at an end of the dent portion which is close to the shaft.

In the folder type UV curing machine for nails according to another embodiment of the present disclosure, the upper member may include a tilting member inclined toward the lower member based on a tilting shaft formed at one surface of the upper member which faces the lower member, and the lighting unit may be formed at the tilting member.

In the folder type UV curing machine for nails according to another embodiment of the present disclosure, the tilting shaft may extend in a direction perpendicular to the shaft to intersect the upper member, the tilting member may include a first tilting member and a second tilting member formed at both sides based on the tilting shaft, and the first tilting member and the second tilting member may be inclined to be closer to the lower member as being farther from the tilting shaft.

In the folder type UV curing machine for nails according to another embodiment of the present disclosure, when the upper member rotates based on the shaft to create a space between the upper member and the lower member, the tilting member may be inclined toward the lower member.

In the folder type UV curing machine for nails according to another embodiment of the present disclosure, a protruding portion may be formed at one surface of the lower member, which faces the upper member, to display a position of the curing target

In the folder type UV curing machine for nails according to another embodiment of the present disclosure, the lighting unit may be a LED UV lamp.

Features and advantages of the present disclosure will be apparent from the following detailed description taken in conjunction with the accompanying drawings.

Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

According to the present disclosure, since the lower member and the upper member are coupled by means of a hinge, the folder type UV curing machine for nails may have a small size and therefore be carried easily.

In addition, according to the present disclosure, since only a specific wavelength required for curing is emitted among ultraviolet rays by using a LED UV lamp, it is possible to prevent the folder type UV curing machine for nails from giving a bad influence on the skin.

Moreover, according to the present disclosure, since the display unit for forming a dent portion or emitting light to display a curing target is provided, the curing target may be placed at an accurate position, thereby enhancing the curing efficiency.

In addition, according to the present disclosure, since an uneven portion or a prism sheet is formed at the lower member, it is possible to prevent the ultraviolet rays emitted from a lighting unit from giving a bad influence on the eyes of a user.

In addition, according to the present disclosure, since the dent portion is formed with a slant, the fingers may be placed conveniently during a curing process, and a suitable distance may be ensured from the nail serving as a curing target to a lighting unit, thereby preventing a burning phenomenon.

In addition, according to the present disclosure, since a step portion protruding upwards is formed at the end of the dent portion to prevent the curing target from going into the curing machine too much, it is possible to prevent the UV gel from being damaged before the curing process or the curing machine from being contaminated by the UV gel.

In addition, according to the present disclosure, since the lighting unit is formed at a tilting member which is inclined based on the tilting shaft toward the lower member, the nails of all fingers may maintain substantially the same distance from the lighting unit. Therefore, the UV gel curing quality may be uniformly obtained at the nails of all fingers.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIGS. 1, 2a, 2b, and 2c are perspective views showing a folder type UV curing machine for nails according to the first embodiment of the present disclosure;

FIG. 3 is a cross sectional view showing a folder type UV curing machine for nails according to a comparative example of the present disclosure;

FIG. 4 is a cross sectional view showing the folder type UV curing machine for nails according to the first embodiment of the present disclosure;

FIGS. 5, 6, 7, and 8 are perspective views for illustrating an operating process of the folder type UV curing machine for nails according to the first embodiment of the present disclosure;

FIGS. 9, 10, and 11 are perspective views showing a folder type UV curing machine for nails according to the second embodiment of the present disclosure;

FIGS. 12, 13a, 14a, and 14b are perspective views showing a folder type UV curing machine for nails according to the third embodiment of the present disclosure;

FIG. 15 is a cross sectional view showing the folder type UV curing machine for nails according to the third embodiment of the present disclosure;

FIG. 16 is a front view showing the folder type UV curing machine for nails according to the third embodiment of the present disclosure;

FIGS. 17a and 17b are cross sectional views showing a distance difference between a curing target and a lighting unit when the folder type UV curing machine for nails according to the third embodiment of the present disclosure does not have a tilting member; and

FIG. 18 is a cross sectional view showing a distance difference between the curing target and the lighting unit when the folder type UV curing machine for nails according to the third embodiment of the present disclosure has a tilting member.

### DETAILED DESCRIPTION OF EMBODIMENTS

Objects, specific advantages and new features of the present disclosure will be more apparent from the following detailed description and embodiments taken in conjunction with the accompanying drawings. In the specification, when reference numerals are endowed to components in each drawing, it should be noted that like reference numerals denote like elements even though they are depicted in several drawings. In addition, the terms “first”, “second”, and the like are used for distinguishing one component from another, and components are not limited to the terms. Hereinafter, in a case where detailed description of known functions or configurations in relation to the present disclosure is judged as unnecessarily making the essence of the present disclosure vague, the detailed description will be excluded.

Hereinafter, preferred embodiments of terminal and method for using cloud services will be described in detail with reference to the accompanying drawings.

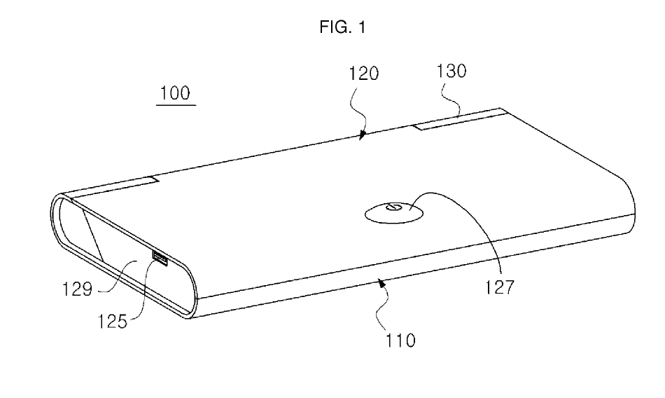

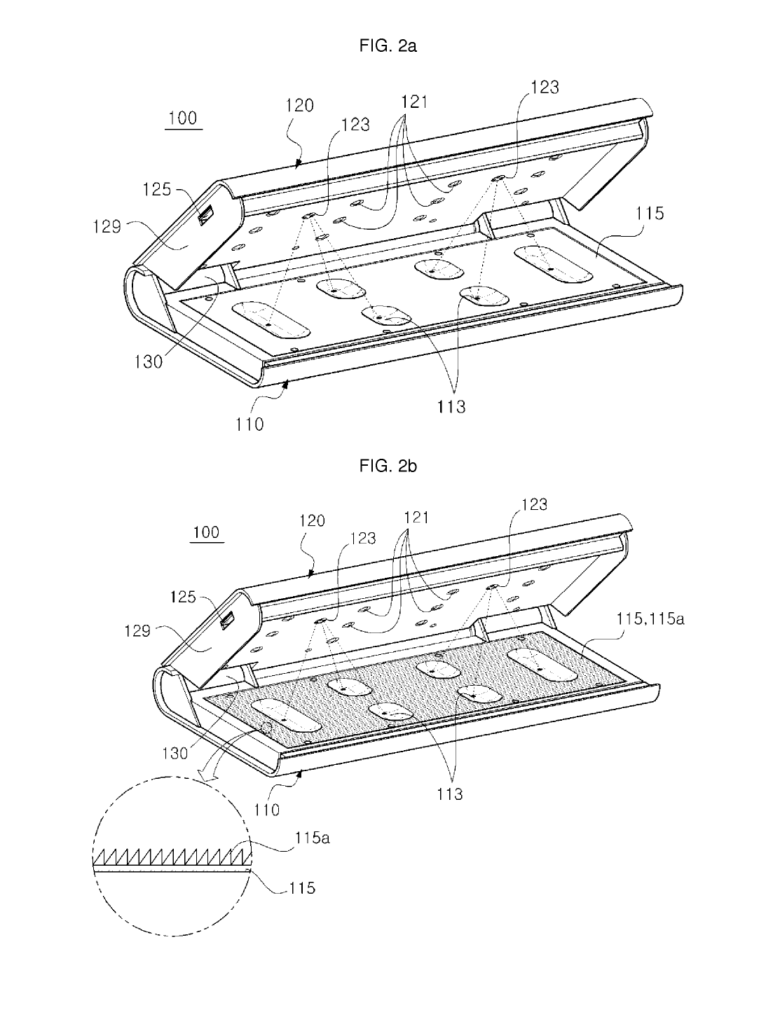

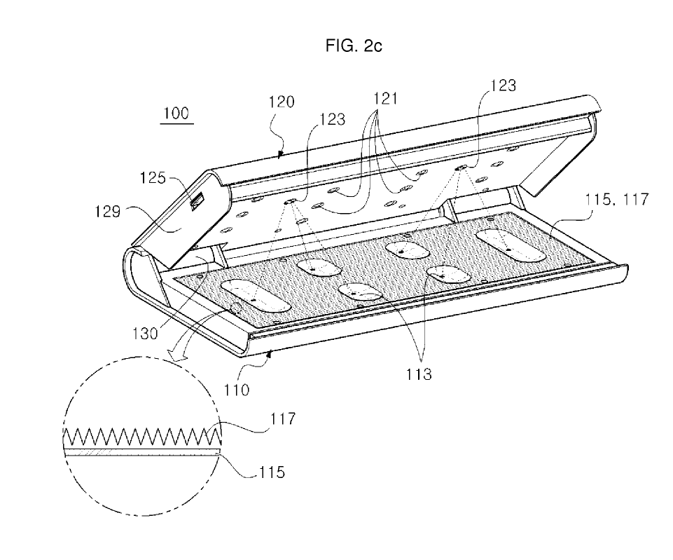

FIGS. 1 and 2a, 2b, and 2c are perspective views showing a folder type UV curing machine for nails according to the first embodiment of the present disclosure.

As shown in FIGS. 1 and 2a, 2b, and 2c, a folder type UV curing machine for nails 100 according to the first embodiment includes a lower member 110 on which a curing target is placed, and an upper member 120 coupled to the lower member 110 by means of a hinge based on a shaft 130 to be rotatable within a predetermined angle based on the shaft 130 and having a lighting unit 121 for emitting ultraviolet rays toward the lower member 110.

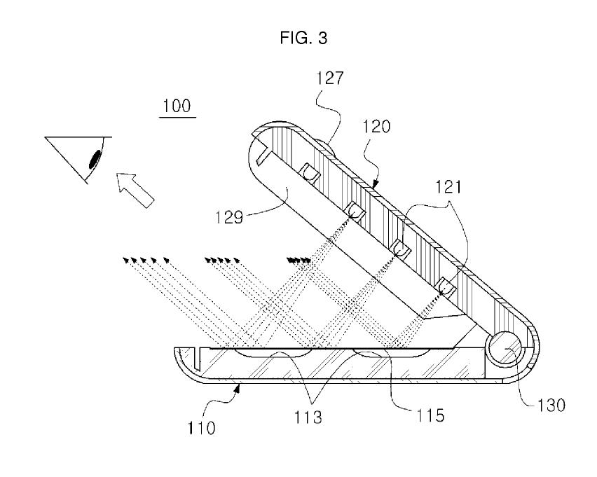

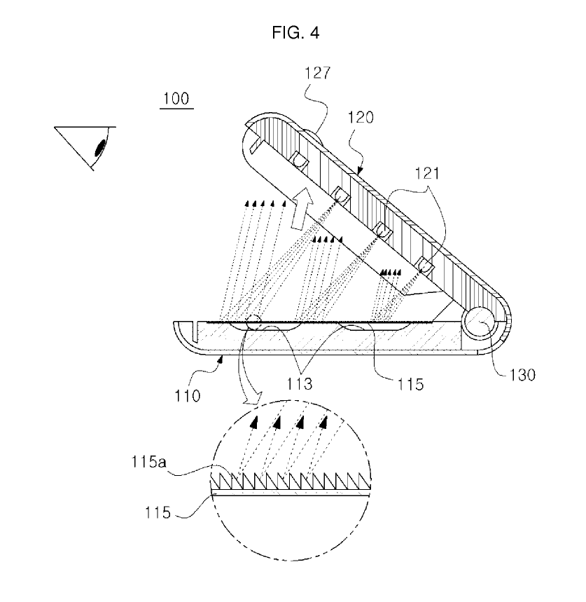

A curing target to be cured by ultraviolet rays is placed on the lower member 110. The lower member 110 is coupled to the upper member 120 by means of a hinge based on the shaft 130, and its lower surface is supported by the ground or the like. In detail, the lower member 110 has a plate shape, and the curing target is placed on the upper surface of the lower member 110 which faces the upper member 120. At this time, the curing target is defined as including nails or toenails coated with an ultraviolet gel (UV gel). In addition, a dent portion 113 for displaying a position of the curing target may be formed at the lower member 110. Here, the dent portion 113 may be formed concavely corresponding to the shape of nails or toenails. Therefore, if a nail or toenail is placed in the dent portion 113, the nail or toenail serving as the curing target may be naturally placed at an accurate position to which ultraviolet rays are emitted from the lighting unit 121. Since the curing target is placed at an accurate position as described above, the UV gel may be cured effectively while minimizing the exothermic reaction. Meanwhile, a reflection unit 115 such as a reflector for reflecting the ultraviolet rays emitted from the lighting unit 121 may be formed at the lower member 110. By reflecting the ultraviolet rays using the reflection unit 115, the curing efficiency may be further enhanced. However, if the ultraviolet rays reflected by the reflection unit 115 are emitted out of the folder type UV curing machine for nails 100 as shown in FIG. 3, the ultraviolet rays may give a bad influence on the eyes of a user or the like. Here, the folder type UV curing machine for nails 100 according to the first embodiment may prevent the ultraviolet rays from being emitted outwards by forming an uneven portion 115a (see FIG. 2b) or a prism sheet 117 (see FIG. 2c) at the reflection unit 115. In detail, as shown in FIG. 4, the uneven portion 115a may be formed at the reflection unit 115, for example, with a right-angled triangular section. At this time, the uneven portion 115a reflects ultraviolet rays on the oblique side of its right-angled triangular shape, and the ultraviolet rays reflected by the uneven portion 115a are oriented toward the upper member 120. In other words, the uneven portion 115a may prevent ultraviolet rays from being emitted outwards by reflecting the ultraviolet rays toward the upper member 120. Meanwhile, in addition to the uneven portion 115a, the prism sheet 117 may be formed at the reflection unit 115 as shown in FIG. 2c. Here, since the prism sheet 117 may adjust an ultraviolet emitting angle, it is possible to emit ultraviolet rays toward the upper member 120 and therefore prevent the ultraviolet rays from being emitted outwards. At this time, the prism sheet 117 may be made by forming a strip-type micro prism at a parent material made of PET or the like.

The upper member 120 is coupled to the lower member 110 by means of a hinge based on the shaft 130 and is rotatable within a predetermined angle based on the shaft 130. Here, the upper member 120 has a plate shape, similar to the lower member 110, and a lighting unit 121 is provided at a lower surface of the upper member 120 which faces the lower member 110. For example, the lighting unit 121 may have a plurality of lamps and be provided in a hole formed at one surface of the upper member 120. At this time, the lighting unit 121 is not specially limited as long as it may serve as a lamp capable of curing a UV gel. However, a UV lamp generally used as the lighting unit 121 not only emits a specific wavelength but also various wavelengths, which may have bad curing efficiency and give a bad influence on the skin. Therefore, the folder type UV curing machine for nails 100 according to the first embodiment may use a light emitting diode ultraviolet lamp (LED UV lamp) as the lighting unit 121. Here, the LED UV lamp emits only a specific wavelength (UV-A) required for curing, among ultraviolet lays, thereby enhancing the curing efficiency and preventing a bad influence from being unnecessarily given to the skin. In addition, a plate 129 protruding downwards may be provided along a rim of the upper member 120 to focus ultraviolet rays to the curing target and prevent the ultraviolet rays from being emitted in a lateral direction of the upper member 120. Here, the plate 129 formed at the upper member 120 is disposed at a side of the lower member 110 when the upper member 120 contacts the lower member 110 (see FIG. 1). Meanwhile, a display unit 123 (see FIGS. 2a to 2c) for emitting light to display a position of the curing target may be provided at the upper member 120. Here, the display unit 123 may emit light such as visible rays, which may be recognized by a user, to a position at which the lighting unit 121 emits ultraviolet rays. If the display unit 123 emits light as described above, a nail or toenail serving as the curing target may be placed at an accurate position to which the lighting unit 121 emits ultraviolet rays. By guiding the curing target to be placed at an accurate position, it is possible to effectively cure the UV gel while minimizing the exothermic reaction. In addition, as shown in FIG. 1, a power socket 125 may be provided at the upper member 120 to supply power, and an on/off switch 127 may also be provided to turn on or off the power.

In the folder type UV curing machine for nails 100 according to the first embodiment, the lower member 110 and the upper member 120 are coupled by means of a hinge. Therefore, the upper member 120 and the lower member 110 contact each other to be closed when not in use (see FIG. 1), and when in use (see FIGS. 2a to 2c), the upper member 120 rotates by a predetermined angle based on the shaft 130 into an opened state in which a predetermined space is provided between the upper member 120 and the lower member 110. As a result, when not in use (see FIG. 1), the upper member 120 and the lower member 110 having a plate shape as a whole contact each other to minimize their volume, which allows the UV curing machine to be easily carried. However, when in use (see FIGS. 2a to 2c), since the upper member 120 rotates by a predetermined angle based on the shaft 130 to give a predetermined space between the upper member 120 and the lower member 110, it is possible to give a sufficient space to the lower member 110 so that the curing target may be placed therein.

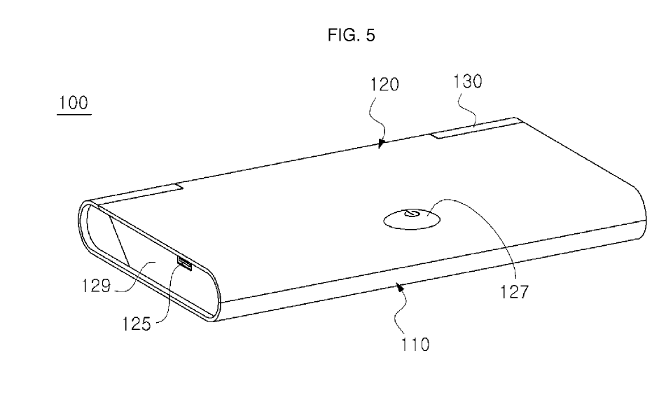

FIGS. 5 to 8 are perspective views for illustrating an operating process of the folder type UV curing machine for nails according to the first embodiment of the present disclosure.

First, as shown in FIG. 5, before the folder type UV curing machine for nails 100 according to the first embodiment is used, the upper member 120 and the lower member 110 having a plate shape contact each other to be closed. Therefore, it is possible to minimize the volume of the curing machine, and the curing machine may be easily carried.

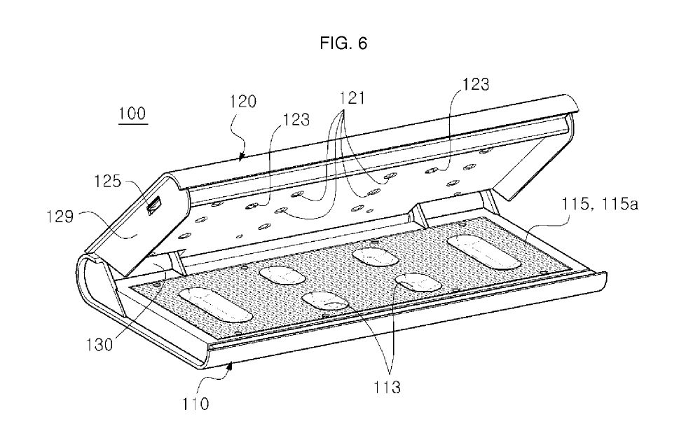

Next, as shown in FIG. 6, in order to use the folder type UV curing machine for nails 100 according to the first embodiment, the upper member 120 is rotated by a predetermined angle based on the shaft 130. If the upper member 120 is rotated by a predetermined angle, the upper member 120 and the lower member 110 come to an opened state with a space between them.

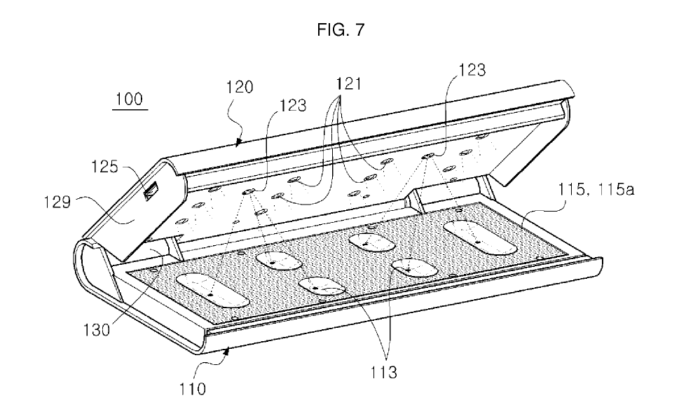

Next, as shown in FIG. 7, if the on/off switch 127 is used to turn on the power, the lighting unit 121 emits ultraviolet rays toward the lower member 110. At this time, the lower member 110 includes the reflection unit 115 such as a reflector to reflect the ultraviolet rays emitted from the lighting unit 121. Depending on the angle between the upper member 120 and the lower member 110, the reflected ultraviolet rays may be emitted outwards. However, since the uneven portion 115a (or, the prism sheet 117) is formed at the lower member 110, ultraviolet rays are reflected only toward the upper member 120, thereby preventing the ultraviolet rays from being emitted outwards.

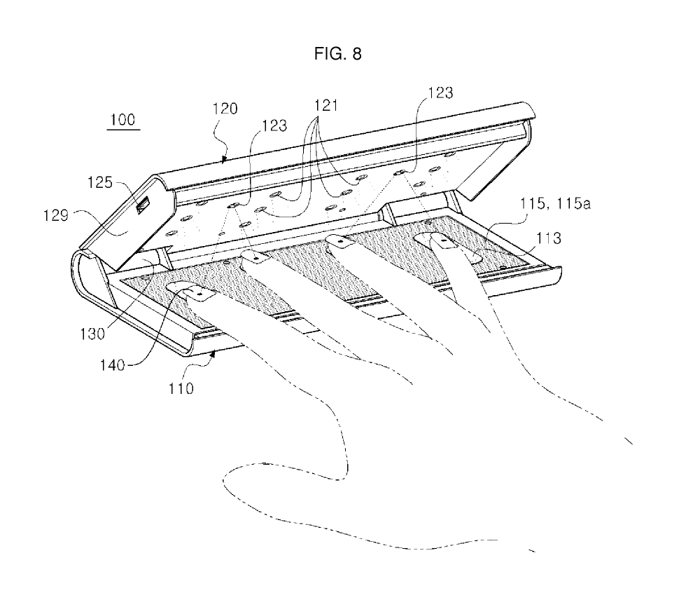

Next, as shown in FIG. 8, a nail serving as the curing target 140 is placed on the lower member 110. In detail, if the finger is placed in the dent portion 113 concavely formed at the lower member 110, the nail serving as the curing target 140 may be naturally placed at an accurate position to which ultraviolet rays are emitted from the lighting unit 121. If the nail is placed at a position of light emitted from the display unit 123 provided at the upper member 120, instead of the dent portion 113, the nail serving as the curing target 140 may be naturally placed at an accurate position to which ultraviolet rays are emitted from the lighting unit 121. If the nail serving as the curing target 140 is placed at an accurate position as described above, the UV gel applied to the nail may be cured by means of the ultraviolet rays from the lighting unit 121.

Meanwhile, if the curing process is completed, the on/off switch 127 is used to turn off the power, and the upper member 120 is rotated by a predetermined angle so that the upper member 120 and the lower member 110 contact each other to be closed.

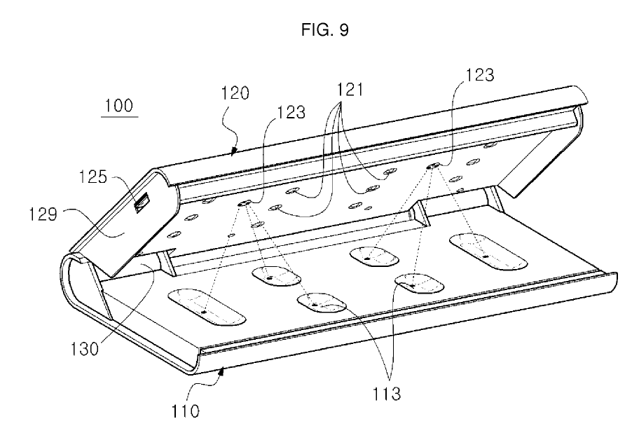

FIGS. 9 to 11 are perspective views showing a folder type UV curing machine for nails according to the second embodiment of the present disclosure.

Even through the lower member 110 includes the reflection unit 115 such as a reflector in the first embodiment above, the reflection unit 115 is not indispensable in the present disclosure.

For example, as shown in FIG. 9, the lower member 110 may not include the reflection unit 115.

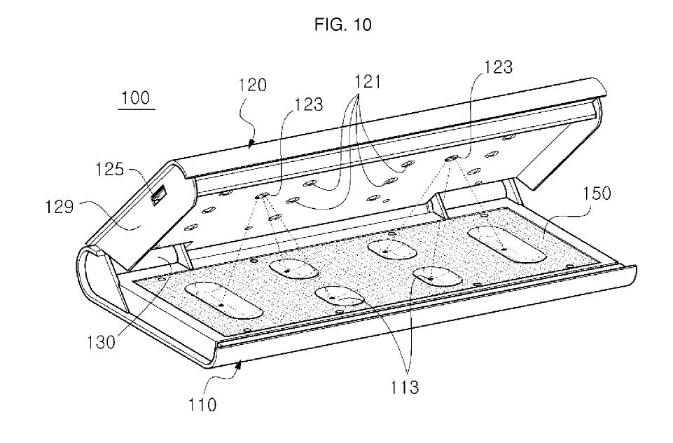

In addition, as shown in FIG. 10, a matt layer 150 which does not substantially reflect light may be formed. By forming the matt layer 150 as described above, it is possible to prevent ultraviolet rays emitted by the lighting unit 121 from being reflected by the lower member 110 and giving a bad influence on the eyes of a user or the like. Here, even though the matt layer 150 is illustrated as a separate layer in the figure, the matt layer 150 may not be formed as a separate layer but the upper surface of the lower member 110 may have a matt property.

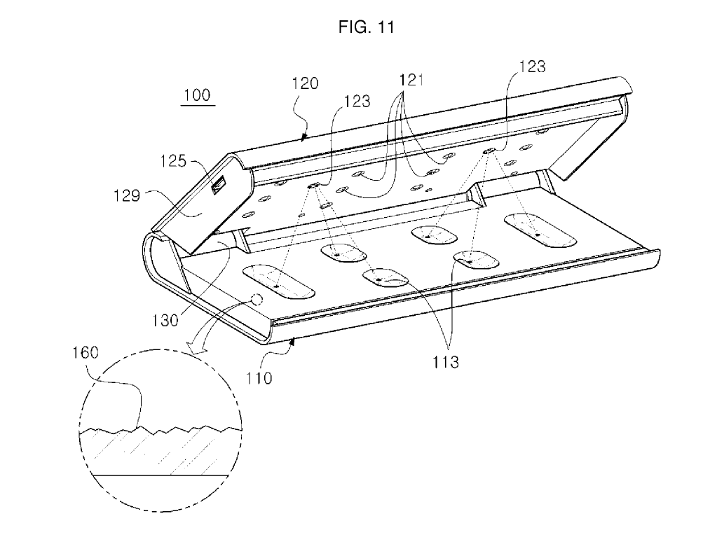

In addition, as shown in FIG. 11, the upper surface of the lower member 110 may have a specific roughness 160. The specific roughness 160 may have a surface roughness of Ra=0.5a to 15a, Rz=2.0z to 100z according to JIS B 0601-1982. If the upper surface of the lower member 110 has a surface roughness of Ra=0.5a to 15a, Rz=2.0z to 100z as described above, ultraviolet rays are irregularly reflected on the upper surface of the lower member 110. Therefore, as ultraviolet rays are reflected by the lower member 110, it is possible to prevent the ultraviolet rays from being reflected out of the folder type UV curing machine for nails 100 to the maximum. In actual experiments, it has been found that an irregular reflection ratio is very high if the upper surface of the lower member 110 has a surface roughness of Ra=0.5a to 15a, Rz=2.0z to 100z. Meanwhile, if the surface roughness is too low below the above range, the irregular reflection ratio lowers rapidly, and the upper surface of the lower member 110 substantially reflects ultraviolet rays. In addition, if the surface roughness is too high over the above range, the irregular reflection ratio does not substantially increase but causes difficult fabrication and excessive production costs.

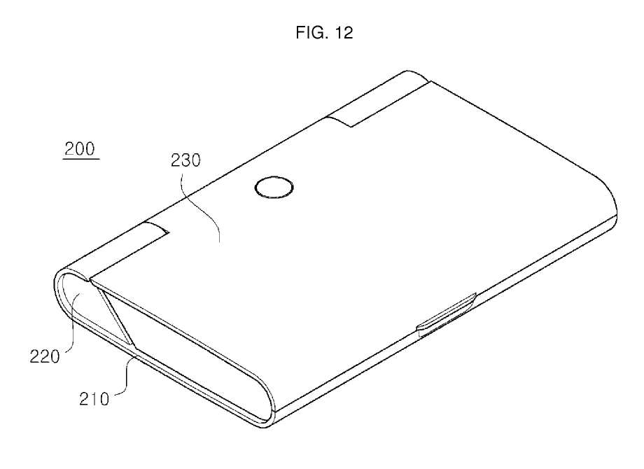

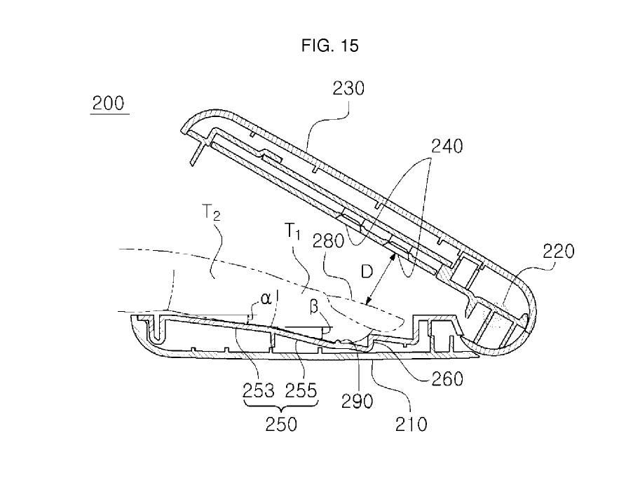

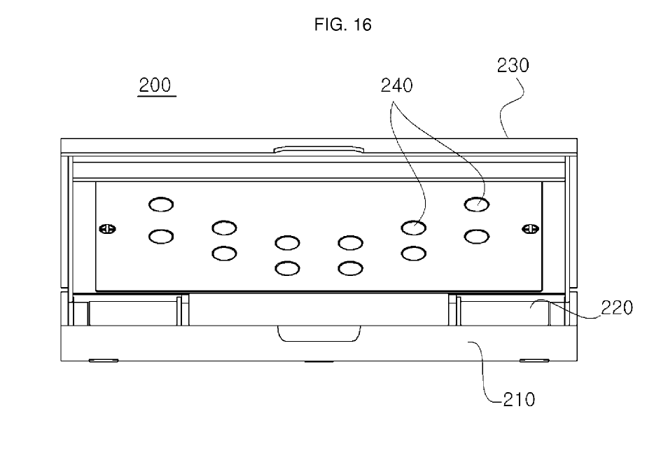

FIGS. 12, 13a, 13b, 14a, and 14b are perspective views showing a folder type UV curing machine for nails according to the third embodiment of the present disclosure, FIG. 15 is a cross sectional view showing the folder type UV curing machine for nails according to the third embodiment of the present disclosure, and FIG. 16 is a front view showing the folder type UV curing machine for nails according to the third embodiment of the present disclosure.

As shown in FIGS. 12, 13a, 13b, 14a, 14b, 15 and 16, the folder type UV curing machine for nails 200 according to the third embodiment includes a lower member 210 on which a curing target 280 is placed, an upper member 230 coupled to the lower member 210 by means of a hinge based on a shaft 220 to be rotatable within a predetermined angle based on the shaft 220, and a lighting unit 240 provided at the upper member 230 to emit ultraviolet rays toward the lower member 210. Here, a dent portion 250 is concavely formed at one surface of the lower member 210, which faces the upper member 230, to display a position of the curing target 280, and the dent portion 250 is inclined to have a greater depth as being closer to the shaft 220.

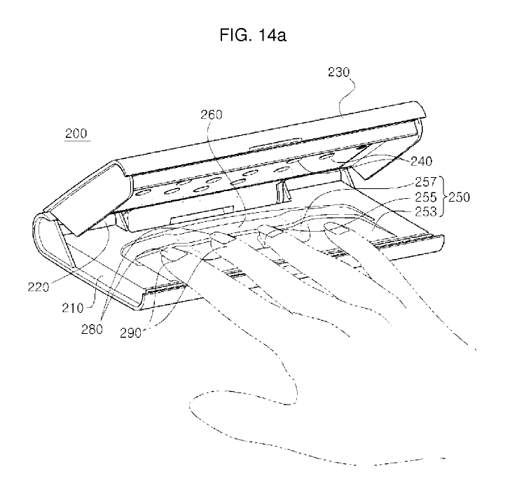

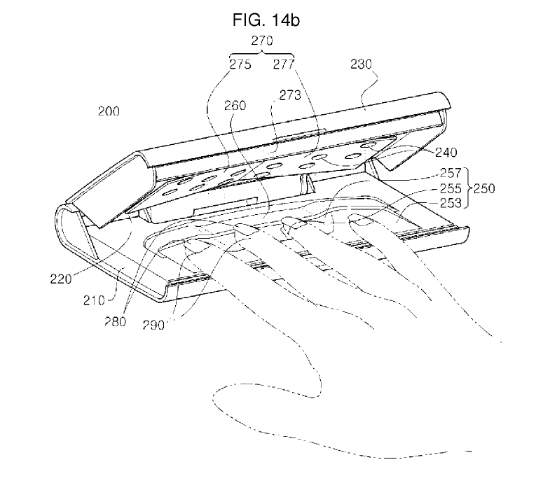

A curing target 280 (see FIGS. 14a, 14b, and 15) to be cured by ultraviolet rays is placed on the lower member 210. The lower member 210 is coupled to the upper member 230 by means of a hinge based on the shaft 220 and supported by the ground or the like. In detail, the lower member 210 has a plate shape, and the curing target 280 is placed on one surface of the lower member 210 which faces the upper member 230. At this time, the curing target 280 is defined as including nails or toenails coated with an ultraviolet gel (UV gel).

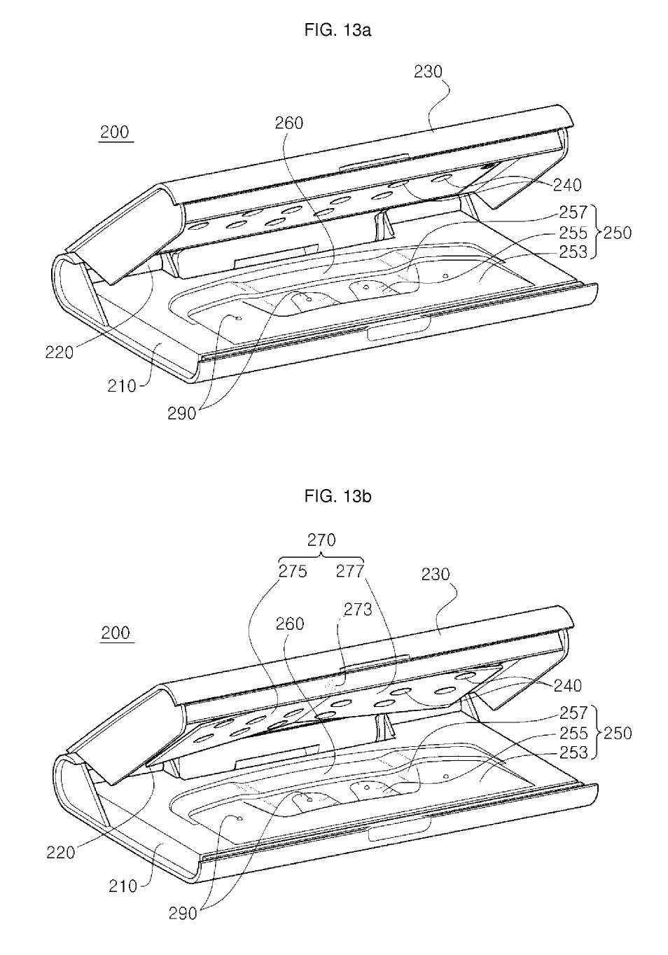

In addition, a dent portion 250 for displaying a position of the curing target 280 may be concavely formed at one surface of the lower member 210 which faces the upper member 230. For example, the dent portion 250 may be formed to have a space at which the finger may be placed. Therefore, if the finger is placed in the dent portion 250, a nail serving as the curing target 280 may be naturally placed at an accurate position to which ultraviolet rays are emitted from the lighting unit 240. Since the curing target 280 is placed at an accurate position as described above, the UV gel may be effectively cured. In addition, as shown in FIG. 15, the dent portion 250 may be inclined to have a greater depth as closer to the shaft 220. If the dent portion 250 is inclined as described above, the finger may be conveniently placed during the curing process. Further, since the nail serving as the curing target 280 may ensure a suitable distance D from the lighting unit 240, it is possible to prevent a burning phenomenon. In more detail, the dent portion 250 may include a first dent portion 253 and a second dent portion 255 having different inclined angles. In other words, the dent portion 250 may include a first dent portion 253 having a first inclined angle α and a second dent portion 255 having a second inclined angle β different from the first inclined angle α. At this time, the second dent portion 255 extends from the first dent portion 253 toward the shaft 220, and the second inclined angle β of the second dent portion 255 is greater than the first inclined angle α of the first dent portion 253. Therefore, if the finger is placed in the dent portion 250, a distal knuckle T₁ of a finger having a relatively greater bending angle may be placed in the second dent portion 255 having the second inclined angle β which is relatively greater, and a middle knuckle T₂ of a finger having relatively smaller bending angle may be placed in the first dent portion 253 having the first inclined angle α which is relatively smaller. As a result, by forming the first dent portion 253 and the second dent portion 255 having different inclined angles are formed, the fingers may be placed more conveniently. In fact, when the fingers were placed in the first dent portion 253 designed to have the first inclined angle α of 7° and the second dent portion 255 designed to have the second inclined angle β of 15°, the user felt convenience during the curing process. Designing the first dent portion 253 to have the first inclined angle α of 7° and the second dent portion 255 to have the second inclined angle β of 15° is just an example, and the present disclosure is not limited thereto. Meanwhile, as shown in FIGS. 13a, 13b, 14a, and 14b, the second dent portion 255 may have a shape corresponding to the finger. For example, two second dent portions 255 may be formed to correspond to the middle finger and the ring finger (the fourth finger). Additionally, a third dent portion 257 may be formed at the outer side of the two second dent portions 255. At this time, the third dent portion 257 may have a third inclined angle between the first inclined angle α of the first dent portion 253 and the second inclined angle β of the second dent portion 255.

In addition, as shown in FIG. 15, a step portion 260 protruding upwards may be formed at an end of the dent portion 250 which is close to the shaft 220. The step portion 260 may prevent the nail serving as the curing target 280 from going toward the shaft 220 (into the curing machine 200) too much. In other words, the tip of the finger is blocked by the step portion 260 so that the nail serving as the curing target 280 does not go into the curing machine 200 too much. Therefore, it is possible to prevent the UV gel of the nail form being damaged due to the contact with the upper member 230 before the curing process or prevent the upper member 230 or the like from being contaminated by the UV gel.

Meanwhile, as shown in FIGS. 13a, 13b, 14a, and 14b, in order to display an accurate position of the curing target 280, a protruding portion 290 may be additionally formed at one surface of the lower member 210 which faces the upper member 230. The protruding portion 290 protrudes from the lower member 210 and may display an accurate position of each finger. Therefore, if the finger is placed on the protruding portion 290, the nail serving as the curing target 280 may be naturally placed at an accurate position to which ultraviolet rays are emitted from the lighting unit 240.

The upper member 230 is coupled to the lower member 210 by means of a hinge based on the shaft 220 and is rotatable within a predetermined angle based on the shaft 220. Here, the upper member 230 has a plate shape, similar to the lower member 210, and a lighting unit 240 is provided at one surface of the upper member 230 which faces the lower member 210. For example, the lighting unit 240 may have a plurality of lamps and be provided in a hole formed at one surface of upper member 230. At this time, the lighting unit 240 is not specially limited as long as it may serve as a lamp capable of curing a UV gel. However, a UV lamp generally used as the lighting unit 240 not only emits a specific wavelength but also various wavelengths, which may have bad curing efficiency and give a bad influence on the skin. Therefore, the folder type UV curing machine for nails 200 according to the third embodiment may use a light emitting diode ultraviolet lamp (LED UV lamp) as the lighting unit 240. Here, the LED UV lamp emits only a specific wavelength (UV-A) required for curing, among ultraviolet lays, thereby enhancing the curing efficiency and preventing a bad influence from being unnecessarily given to the skin. In addition, as shown in FIG. 16, the lighting unit 240 having a plurality of lamps may be formed to be closer to the shaft 220 as being closer to the center of the upper member 230. In other words, the lighting unit 240 having a plurality of lamps has a “V” shape as a whole, which may suitably cope with the fingers having different lengths.

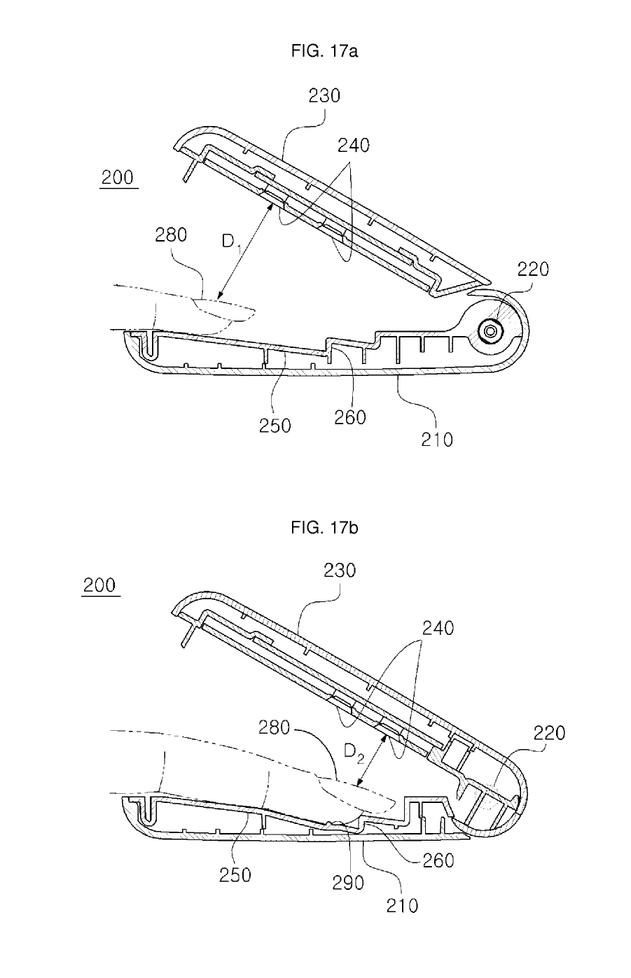

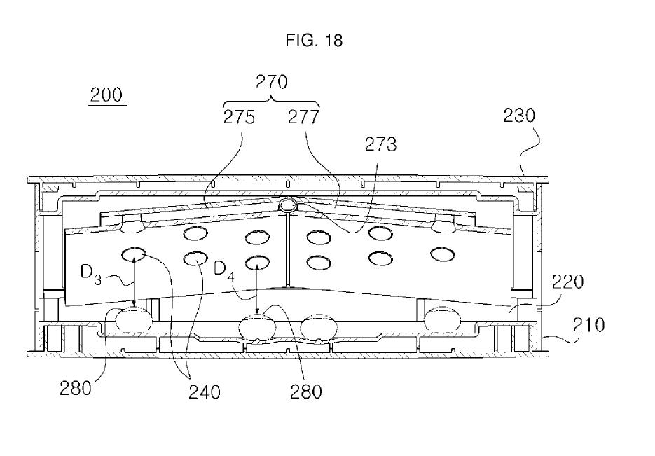

Meanwhile, FIGS. 17a and 17b are cross sectional views showing a distance difference between a curing target and a lighting unit when the folder type UV curing machine for nails according to the third embodiment of the present disclosure does not have a tilting member, and FIG. 18 is a cross sectional view showing a distance difference between the curing target and the lighting unit when the folder type UV curing machine for nails according to the third embodiment of the present disclosure has a tilting member.

Due to the slope between the lower member 210 and the upper member 230, as shown in FIG. 17a, a little finger or a index finger having a relatively short length may have a relatively great distance D₁ to the lighting unit 240, and as shown in FIG. 17b, a middle finger or a ring finger (a fourth finger) having a relatively great length may have a relatively short distance D₂ to the lighting unit 240. In this case, the UV gel curing quality may not be uniform for all fingers. However, since a tilting member 270 is provided as shown in FIG. 18 and the lighting unit 240 is formed at the tilting member 270, the above problem may be solved. In detail, the tilting member 270 may be inclined toward the lower member 210 based on a tilting shaft 273 formed at one surface of the upper member 230 which faces the lower member 210. At this time, the tilting shaft 273 may extend in a direction perpendicular to the shaft 220 along the center of the upper member 230 to intersect the upper member 230, and the tilting member 270 may include a first tilting member 275 and a second tilting member 277 formed at both sides based on the tilting shaft 273. Since the first tilting member 275 and the second tilting member 277 are inclined toward the lower member 210 based on the tilting shaft 273, the first tilting member 275 and the second tilting member 277 may be closer to the lower member 210 as being farther from the tilting shaft 273. Therefore, since the lighting unit 240 formed at the first and second tilting members 275, 277 is closer to the curing target 280 placed on the lower member 210 as being farther from the tilting shaft 273, the difference of distance between the curing target 280 (the nail) and the lighting unit 240, which may be caused by the slope between the lower member 210 and the upper member 230, may be minimized. In other words, since the lighting unit 240 is formed at the first and second tilting members 275, 277, the nails of all fingers may maintain substantially the same distance (D₃≈D₄) to the lighting unit 240, and accordingly the UV gel curing quality may be uniform for the nails of all fingers. In fact, when the first and second tilting members 275, 277 were designed to be inclined with an angle of 14° toward the lower member 210 based on the tilting shaft 273 and then fingers are placed thereon, the distance to the lighting unit 240 was identically about 15 mm for the nails of all fingers. However, designing the first and second tilting members 275, 277 to be inclined with an angle of 14° based on the tilting shaft 273 is just an example, and the present disclosure is not limited thereto.

In the folder type UV curing machine for nails 200 according to the third embodiment, the lower member 210 and the upper member 230 are coupled by means of a hinge. Therefore, the upper member 230 and the lower member 210 contact each other to be closed when not in use (see FIG. 12), and when in use (see FIGS. 13a, 13b, 14a, and 14b), the upper member 230 rotates by a predetermined angle based on the shaft 220 into an opened state in which a predetermined space is provided between the upper member 230 and the lower member 210. As a result, when not in use (see FIG. 12), the upper member 230 and the lower member 210 having a plate shape as a whole contact each other to minimize their volume, which allows the UV curing machine to be easily carried. However, when in use (see FIGS. 13a, 13b, 14a, and 14b), since the upper member 230 rotates by a predetermined angle based on the shaft 220 to give a predetermined space between the upper member 230 and the lower member 210, it is possible to give a sufficient space to the lower member 210 so that the curing target 280 may be placed therein. In addition, as shown in FIGS. 13b and 14b, if the upper member 230 rotates based on the shaft 220 to create a space between the upper member 230 and the lower member 210 (into an open state), the first and second tilting members 275, 277 are inclined due to their weights toward the lower member 210 based on the tilting shaft 273. Since the first and second tilting members 275, 277 are inclined, the UV curing quality may be uniformly for the nails of all fingers, as described above.

Referring to FIGS. 12, 13a, 13b, 14a, and 14b, an operating process of the folder type UV curing machine for nails according to the third embodiment of the present disclosure will be described as follows.

First, as shown in FIG. 12, before the folder type UV curing machine for nails 200 according to the third embodiment is used, the upper member 230 and the lower member 210 contact each other. Therefore, it is possible to minimize the volume of the curing machine, and the curing machine may be easily carried.

Next, as shown in FIGS. 13a and 13b, in order to use the folder type UV curing machine for nails 200 according to the third embodiment, the upper member 230 is rotated by a predetermined angle based on the shaft 220. If the upper member 230 is rotated by a predetermined angle, the upper member 230 and the lower member 210 come to an opened state with a space between them. In addition, as shown in FIG. 13b, the first and second tilting members 275, 277 having the lighting unit 240 are inclined toward the lower member 210 based on the tilting shaft 273 due to their weights.

Next, as shown in FIGS. 14a and 14b, if turning on the power, the lighting unit 240 emits ultraviolet rays toward the lower member 210. At this time, the nail serving as the curing target 280 is placed in the dent portion 250 of the lower member 210. If the finger is placed in the dent portion 250 concavely formed at the lower member 210, the nail serving as the curing target 280 may be naturally placed at an accurate position to which ultraviolet rays are emitted from the lighting unit 240. Further, since the dent portion 250 is inclined, the fingers are convenient during the curing process, and the nail serving as the curing target 280 may maintain a suitable distance from the lighting unit 240, thereby preventing a burning phenomenon. In addition, since the step portion 260 is formed at the end of the dent portion 250, it is possible to prevent the nail serving as the curing target 280 from going into the shaft 220 too much. Accordingly, it is possible to prevent the UV gel of the nail from being damaged due to the contact with the upper member 230 before the curing process or prevent the upper member 230 or the like from being contaminated by the UV gel. Additionally, as shown in FIG. 14b, since the nails of all fingers may maintain substantially the same distance from the lighting unit 240 due to the first and second tilting members 275, 277, the UV gel curing quality may be uniform for the nails of all fingers.

While the present disclosure has been described with respect to the third embodiment, this is just for illustrating the present disclosure in detail, and the present disclosure is not limited thereto. It will be apparent to those skilled in the art that various changes and modifications may be made without departing from the spirit and scope of the present disclosure.

Simple changes or modifications of the present disclosure belong to the scope of the present disclosure, and the protection range of the present disclosure will be apparent from the appended claims.

What is claimed is:

1. A folder type UV curing machine for nails, comprising:
a lower member on which a curing target is placed; and
an upper member coupled to the lower member by means of a hinge based on a shaft to be rotatable within a predetermined angle based on the shaft, the upper member having a lighting unit for emitting ultraviolet rays toward the lower member.

2. The folder type UV curing machine for nails according to claim 1, wherein the lighting unit is a light emitting diode ultraviolet lamp (LED UV lamp).

3. The folder type UV curing machine for nails according to claim 1, wherein the lower member has a dent portion formed to display a position of the curing target.

4. The folder type UV curing machine for nails according to claim 1, further comprising a reflection unit formed at the lower member to reflect the ultraviolet rays.

5. The folder type UV curing machine for nails according to claim 4, further comprising an uneven portion formed at the reflection unit.

6. The folder type UV curing machine for nails according to claim 4, further comprising a prism sheet formed at the reflection unit.

7. The folder type UV curing machine for nails according to claim 1, further comprising a display unit provided at the upper member and emitting light toward the lower member to display a position of the curing target.

8. The folder type UV curing machine for nails according to claim 7, wherein the light is a visible ray.

9. The folder type UV curing machine for nails according to claim 1, further comprising a matt layer formed at an upper surface of the lower member.

10. The folder type UV curing machine for nails according to claim 1, wherein the upper surface of the lower member has a surface roughness of Ra=0.5a to 15a, Rz=2.0z to 100z.

11. A folder type UV curing machine for nails, comprising:
a lower member on which a curing target is placed;
an upper member coupled to the lower member by means of a hinge based on a shaft to be rotatable within a predetermined angle based on the shaft; and
a lighting unit provided at the upper member to emit ultraviolet rays toward the lower member,
wherein a dent portion is formed at one surface of the lower member, which faces the upper member, to display a position of the curing target, and
wherein the dent portion is inclined to have a greater depth as being closer to the shaft.

12. The folder type UV curing machine for nails according to claim 11, wherein the dent portion includes:
a first dent portion having a first inclined angle; and
a second dent portion extending from the first dent portion toward the shaft and having a second inclined angle different from the first inclined angle.

13. The folder type UV curing machine for nails according to claim 12, wherein the second inclined angle is greater than the first inclined angle.

14. The folder type UV curing machine for nails according to claim 11, wherein a step portion protruding upwards is formed at an end of the dent portion which is close to the shaft.

15. The folder type UV curing machine for nails according to claim 11,
wherein the upper member includes a tilting member inclined toward the lower member based on a tilting shaft formed at one surface of the upper member which faces the lower member, and
wherein the lighting unit is formed at the tilting member.

16. The folder type UV curing machine for nails according to claim 15,
wherein the tilting shaft extends in a direction perpendicular to the shaft to intersect the upper member,
wherein the tilting member includes a first tilting member and a second tilting member formed at both sides based on the tilting shaft, and
wherein the first tilting member and the second tilting member are inclined to be closer to the lower member as being farther from the tilting shaft.

17. The folder type UV curing machine for nails according to claim 15, wherein when the upper member rotates based on the shaft to create a space between the upper member and the lower member, the tilting member is inclined toward the lower member.

18. The folder type UV curing machine for nails according to claim 11, wherein a protruding portion is formed at one surface of the lower member, which faces the upper member, to display a position of the curing target.

19. The folder type UV curing machine for nails according to claim 11, wherein the lighting unit is a LED UV lamp.
